(19) United States
(12) Patent Application Publication
(10) Pub. No.: US 2022/0150338 A1
(43) Pub. Date: May 12, 2022

(54) A METHOD AND AN APPARATUS FOR CONNECTING AN AUXILIARY DEVICE TO A PORTABLE COMMUNICATION DEVICE AND AN ADAPTER

(71) Applicant: Oy Stop Noise Finland Ltd, Jyväskylä (FI)

(72) Inventor: Markku NIEMINEN, Laukaa (FI)

(73) Assignee: Oy Stop Noise Finland Ltd, Jyväskylä (FI)

(21) Appl. No.: 17/437,893

(22) PCT Filed: Mar. 10, 2020
(86) PCT No.: PCT/FI2020/050151

§ 371 Date: Sep. 10, 2021

(30) Foreign Application Priority Data
Mar. 11, 2019 (FI) 20195175

(51) Int. Cl. H04M 1/02; H04M 1/72409; H01R 33/94

(52) U.S. Cl. CPC H04M 1/0254; H01R 33/94; H04M 1/724092

(57) ABSTRACT

The present disclosure relates to an adapter, which is configured to be connected in connection with a portable communication device and an auxiliary device. The adapter comprises first attaching means for attaching to the portable communication device, a set of openings for external functions of the portable communication device, and second attaching means for connecting an auxiliary device to the adapter.

### OBJECT OF THE DISCLOSED EMBODIMENTS

The present disclosure relates to an apparatus, which comprises an adapter and an auxiliary device arranged to be connected to it, which apparatus is arranged to be connected in connection with a portable communication device, and which adapter comprises first attaching means for attaching to the portable communication device, a set of openings for external functions of the portable communication device, and second attaching means for connecting the auxiliary device to the adapter, to a method for connecting an apparatus comprising an adapter and an auxiliary device to a portable communication device and to an adapter, by means of which an auxiliary device can be connected to a portable communication device.

### BACKGROUND

Portable communication devices, particularly mobile phones, are used almost everywhere these days. The properties of such devices have advanced very quickly in the last years and they can be used to perform many kinds of operations, for which for example so-called desktop computers were previously used. The use of mobile phones and other mobile communication devices in communication has also grown due to among others the expansion of the geographical cover of mobile phone networks and the growth in data transfer capacity and speed. However, the usability of mobile phones has not advanced at the same rate, but even deteriorated as touch screens have come into use.

In some situations, especially authorities can have in their use a communication device for a special communications network meant for authority use. Thus, it could be advantageous, among other in view of usability, if such a communication device or at least its user interface functions could be combined into a communication device using public mobile communication networks.

### BRIEF SUMMARY

One object of the present disclosure is to raise the state of the art of the field and provide a method for connecting an auxiliary device to a portable communication device by means of an adapter. The disclosed embodiments also relate to an adapter, by which the auxiliary device can be connected to the portable communication device, and an apparatus, which comprises an auxiliary device and means for connecting the auxiliary device to the portable communication device.

More precisely, the method according to the present disclosure is mainly characterized in that in the method, an adapter arranged to be mechanically attached to a portable communication device is selected, in which adapter has been arranged a set of openings for the external connectors of the portable communication device, an auxiliary device is connected to the adapter, which auxiliary device comprises a connector for forming a wired data transfer and/or electricity connection between the portable communication device and the auxiliary device, and the adapter is attached to a wire connector of the portable communication device.

The apparatus according to the disclosed embodiments is mainly characterized in that the auxiliary device comprises a connector for forming a wired data transfer and/or electricity connection between the portable communication device and the auxiliary device.

The adapter according to the disclosed embodiments is mainly characterized in that the adapter comprises means for attaching to a portable communication device, a set of openings for the external connectors of the portable communication device, and means for connecting the auxiliary device to the adapter.

The present disclosure achieves remarkable advantages over solutions of prior art. The adapter according to the disclosed embodiments makes it possible to connect the same auxiliary device to different portable communication devices, among others because it is possible to implement mechanically different adapters, whereby the design of the adapter is planned to correspond to mechanical properties of a desired portable communication device without changing the properties of the adapter related to connecting the auxiliary device. In other words, the same connecting device is arranged to be connected in connection with the portable communication device by selecting such an adapter, which is suitable to be attached to the portable communication device in question.

### DESCRIPTION OF THE DRAWINGS

In the following, the present disclosure will be described in more detail with reference to the appended drawings, in which

FIG. 1a shows as a perspective view an example of an ensemble, which comprises a portable communication device and an adapter and auxiliary device according to an advantageous embodiment of the present disclosure separate from each other,

FIG. 1b shows the adapter and auxiliary device according to FIG. 1a connected together,

FIG. 1c shows the adapter according to FIG. 1a seen from below,

FIG. 1d shows the auxiliary device according to FIG. 1a seen from below,

FIG. 2a shows, seen from the side, the adapter and auxiliary device according to FIG. 1a connected together,

FIG. 2b shows, seen from the side, the adapter and auxiliary device according to FIG. 1a connected together,

FIG. 2c shows, seen from above, the ensemble according to the example of FIG. 1a, which comprises a portable communication device, an adapter and an auxiliary device connected together,

FIG. 3a shows as a simplified block diagram the functional circuits of one device ensemble,

FIG. 3b shows as a simplified block diagram the functional circuits of a second device ensemble,

FIG. 4a shows as a perspective view an auxiliary device according to a second embodiment seen from below,

FIG. 4b shows as a perspective view an auxiliary device according to the embodiment of FIG. 4a seen from above,

FIG. 4c shows a cross-section of the first end of the auxiliary device according to FIG. 4a,

FIGS. 5a and 5b

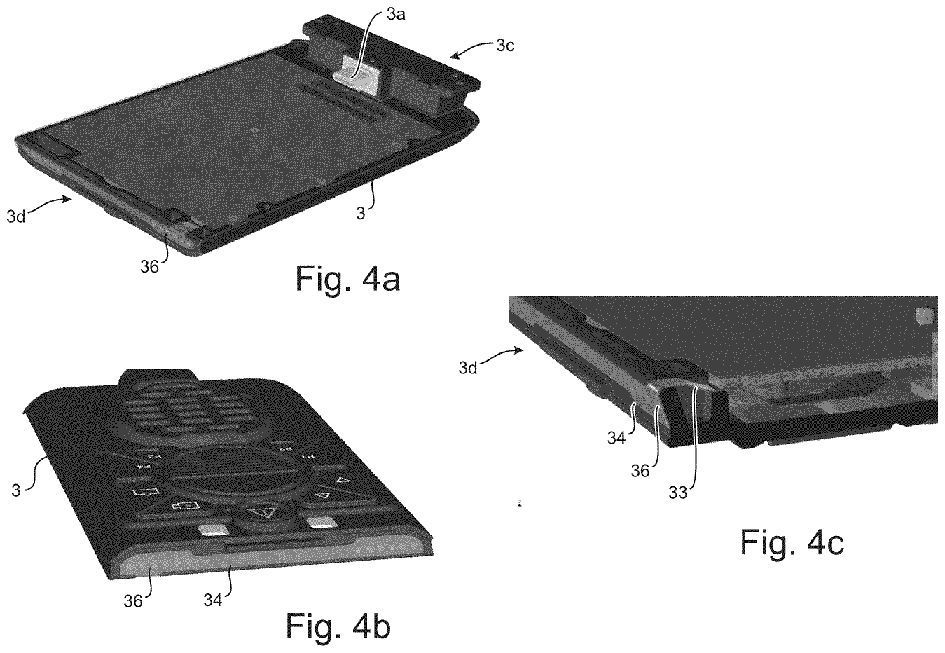

show a detail of the structure of the wire connector of the auxiliary device according to FIG. 4a.

### DETAILED DESCRIPTION OF THE DISCLOSED EMBODIMENTS

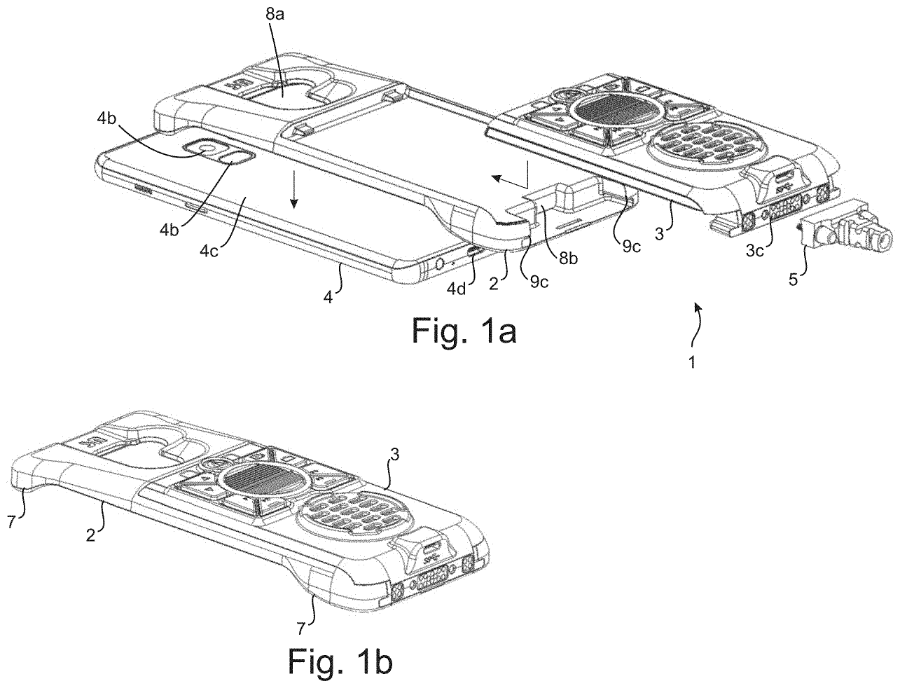

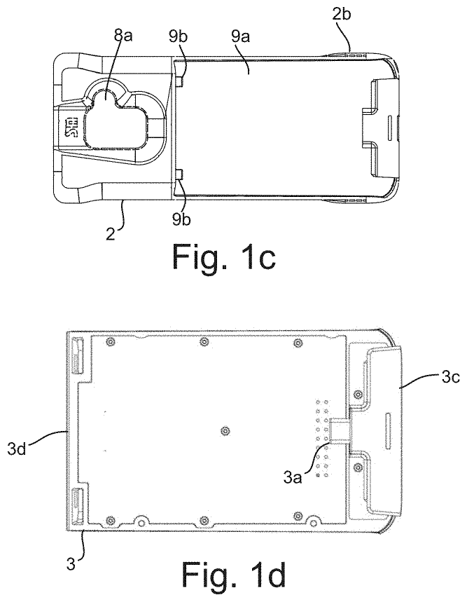

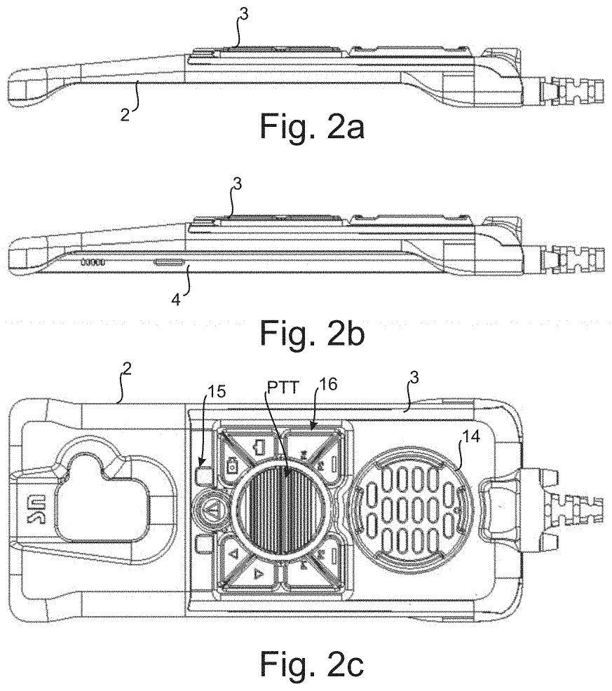

FIG. 1a shows as a perspective view an example of an apparatus ensemble 1, which comprises an adapter 2, an auxiliary device 3 and a portable communication device 4 according to an advantageous embodiment of the present disclosure. In FIG. 1a the adapter 2, the auxiliary device 3 and the portable communication device 4 are shown separate from each other. In the example of FIG. 1a a wire coupling 5 can further be seen, by means of which the auxiliary device 3 and/or portable communication device 4 can be connected in a wired manner to an external object, such as a second communication device, a charging device (not shown in FIG. 1a) or the like.

FIG. 1b shows as a perspective view an exemplary apparatus 6, where the adapter 2 and auxiliary device 3 according to FIG. 1a are connected together.

The adapter 2 according to one advantageous embodiment of the present disclosure comprises among others attaching means 7 for attaching the auxiliary device 3 to the portable communication device 4, advantageously onto the rear cover 4a of the portable communication device 4. Additionally, the adapter 2 can comprise a counter surface 2a (FIG. 1c) or the like, against which the rear cover 4a of the portable communication device 4 can be set. The counter surface 2a can partly or completely be surrounded by one or more border parts 2b, which can function as guides, when the portable communication device 4 is set in connection with the adapter 2. The attaching means 7 can comprise for example claw-like protrusions, grooves formed in the border part 2b and/or corresponding members, supported on which the adapter 2 stays attached to the portable communication device 4. The attaching means 7 and/or the adapter 2 can be somewhat flexible, which can make it easier to set the portable communication device 4 in connection with the adapter 2 and to detach the portable communication device 4 from the adapter 2.

An adapter according to one advantageous embodiment of the present disclosure has a groove in each corner, in which groove one corner of the portable communication device 4 is arranged to be set. Thus, the portable communication device 4 is attached to the adapter 2 in four different spots, but it is clear that the attaching can occur for example in three spots or in more than four spots.

In an adapter 2 according to one advantageous embodiment of the present disclosure the attaching means 7 are magnetic, whereby the attaching can occur under influence of magnetic power. Such attaching means 7 are for example magnets, which are attached or inlaid into the structures of the adapter 2. Thus, for example the rear cover of the portable communication device 4 is at least at the location of the magnets made of a magnetizing material, such as ferromagnetic metal or another ferromagnetic material.

The adapter 2 according to the disclosed embodiments can also have one or more openings 8 for user interface functions of the communication device 4. For example the adapter according to FIG. 1a has one opening 8a at the location of the camera 4b and flashlight 4c of the portable communication device 4 and a second opening 8b at the location of the wire connector 4d. Thus, the adapter 2 does not affect the operation of the camera 4b or flashlight 4c. Through the second opening 8b for example a charging wire can be connected to the portable communication device 4, or as is shown below in this description, a connector 3a in the auxiliary device 3.

The adapter 2 further has means 9 for connecting the auxiliary device 3 in connection with the adapter 2. These means comprise for example an installation recess 9a for receiving the auxiliary device 3, locking means 9b for locking the auxiliary device 3 into place in connection with the installation recess 9a, and guiding means 9c for guiding the auxiliary device 3 into the right place in relation to the wire connector 4d of the portable communication device 4.

The following is a description of different steps of the method according to an advantageous embodiment of the present disclosure by using the apparatus ensemble shown in the enclosed figures as an example. For an adapter 2 such an adapter is selected, the mechanical dimensions of which correspond to the dimensions of the casing of the portable communication device 4, such as a mobile phone, intended to be connected to the adapter 2. It should however be mentioned that a user does not necessarily have several different adapters 2, but has acquired an adapter 2 suitable for the portable communication device 4 he/she uses. On the other hand, the user may have several mechanically different portable communication devices 4, whereby the user can have acquired several adapters 2 for different portable communication devices 4.

It should in this context be mentioned that though the properties of the adapter 2 with regards to the portable communication device 4 intended to be connected thereto may vary, the elements of the adapter 2 intended for connecting the auxiliary device 3 do not change, if the auxiliary device 3 to be used is the same. On the other hand, there can be different auxiliary devices 3, so the properties of adapters 2 intended for different auxiliary devices 3 can vary in that regard.

The selected adapter 2 is connected to the portable communication device 4 with the aid of attaching means 7 in the adapter 2. Thereafter the auxiliary device 3 is connected in connection with the adapter with the aid of means 9 intended for connecting the auxiliary device 3. According to an advantageous embodiment of the present disclosure this occurs so that the auxiliary device 3 is set close to the end of the adapter 2, where the second opening 8b of the adapter is located, which in the example of FIGS. 1a-1c is in the right edge of the adapter. The auxiliary device 3 is slid on the surface of the installation recess 9a in the adapter 2, until the first end 3d of the auxiliary device 3 hits the end of the installation recess 9a. The end of the installation recess 9a has one or more locking means 9b, which push into counter recesses (not shown) in the first end of the auxiliary device 3, so that the friction effect between the locking means 9b and the counter recesses holds the auxiliary device 3 in place relatively tightly.

In connection with the sliding of the auxiliary device 3, also the connector 3a in the auxiliary device is pushed into the wire connector 4d of the portable communication device 4. Thus, a wired data transfer and/or electricity connection is formed between the portable communication device 4 and the auxiliary device 3. Thus, the auxiliary device 3 can be used among others as a user interface of the portable communication device 4.

It is clear that the data transfer connection between the portable communication device 4 and the auxiliary device 3 can also be a wireless connection, whereby information is not necessarily transferred via the wire connector, but it can be used for example for supplying electricity needed by the auxiliary device 3 from the power source of the portable communication device 4.

The auxiliary device 3 can comprise different user interface functions. In the auxiliary device 3 has been placed for example a speaker 14, a microphone 15 and one or more function keys 16. It is however clear that the auxiliary device can comprise only part of the above-mentioned user interface functions, such as only the speaker 14 or microphone 15, or all the user interface functions of the communication device 4. It is also possible that the communication device 4 itself has the above-mentioned functions or part of them. As an example of a wireless communication connection can be mentioned a short-range radio connection, such as Bluetooth® and NFC (near field communication).

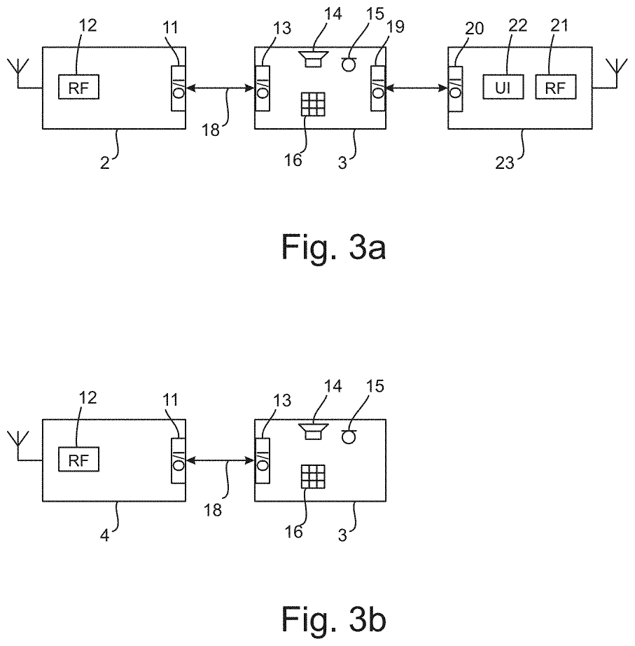

FIG. 3a shows one example of an application, where the auxiliary device 3 is connected to the portable communication device 4 and is also in data transfer connection to a second communication device 23, such as a telephone operating in the authority network. In the embodiment shown above, there does not need to be any other functional connection between the portable communication device 4 and the second communication device 23 than only a mechanical connecting together.

FIG. 3b shows an example of a second application, where the auxiliary device 3 is connected to the portable communication device 4 but not to other communication devices.

In a second advantageous embodiment of the present disclosure, at least part of the user interface functions formed in the auxiliary device 3 can be used also as user interface functions of the second communication device 23. For example if the auxiliary device 3 has a speech key (PTT, Push-to-Talk), it can be used also for performing some function of the second communication device 23, for example a selection key, in camera functions as a key for taking pictures or as a speech key. On the other hand, the auxiliary device 3 can also have other function keys, which can be shared with the portable communication device 4 and the second communication device 23. It is also possible that part of the function keys of the auxiliary device 3 are intended for use only for controlling the functions of the portable communication device 4, such as, for example, a camera key.

The auxiliary device 3 according to the disclosed embodiments can also have other functions than user interface functions, such as an acceleration sensor, a positioning receiver, a gas sensor etc. With the aid of the acceleration sensor it is possible to monitor if the auxiliary device 3 is in motion or stationary, and based on this it can in some use situations be deduced, what the operational readiness of the user of the communication device 4 is at any time and if there is a need to form an automatic alarm etc.

In the following, one example of a use situation for a communication device combination 1 equipped with an auxiliary device 3 according to the disclosed embodiments is described. It is assumed that the auxiliary device 3 has at least a speaker 14, a microphone 15 and function keys 16 and that the auxiliary device 3 is attached in connection with the portable communication device 4. It is additionally assumed that the portable communication device 4 is a so-called smartphone or the like, in which different applications can be installed, such as a one-key call function, which can also be called a push-to-talk function, familiar from radiotelephones. When the user wants to place a call with the portable communication device 4, the user can, for example, press a shortcut key in the auxiliary device 3. When the call is connected, the counterpart's speech or the like can be heard from the speaker 14, and correspondingly when the user wants to speak, he can press the speech key. On the other hand, if the intention is not to use the push-to-talk function but the normal phone functions of the portable communication device 4, the user can, for example, select a speech command function and call a desired number with a speech command or the like. It is clear that the above-mentioned examples are only some possible functions, which can be performed with the apparatus ensemble 1 according to the disclosed embodiments.

One essential feature of the disclosed embodiments is however an adapter 2, by means of which the same auxiliary device 3 can be connected in connection with different portable communication devices 4 by selecting an adapter 2 suited for the portable communication device 4 in question.

In an application according to an advantageous embodiment of the present disclosure, the portable communication device 4 can detect that an auxiliary device 3 has been connected via an adapter 2 to the portable communication device 4. Thus, the portable communication device's 4 own speaker and/or microphone can be switched off and the auxiliary device's 3 speaker 14 and/or microphone 15 can be used instead. This can have among others the advantage that this apparatus ensemble can be used as a speakerphone, because the volume made possible by the speaker 14 of the auxiliary device 3 can be significantly higher than the volume of the portable communication device's 4 own speaker.

The enclosed figures further show a wire connector 5, which can be connected to a wire connection 3c possibly in the auxiliary device 3. Via this wire connection 3c, for example operating voltage can be supplied to the auxiliary device 3 and/or to the portable communication device 4 in order to, for example, charge the battery of the portable communication device 4. It can also be possible to use the wire connection 3c for data transfer between the auxiliary device 3 and/or the portable communication device 4 and some external data transfer device and/or a data processing device. Such an external data transfer device can, for example, be the second communication device 23.

An auxiliary device 3 according to an advantageous embodiment of the present disclosure can have its own battery or another small power source, whereby electric energy does not necessarily need to be supplied to the auxiliary device 3 from the portable communication device 4.

An adapter 2 according to one advantageous embodiment of the present disclosure is equipped with its own battery or other small power source, whereby the adapter 2 has wiring or the like, for example, to the auxiliary device 3 and/or portable communication device 4 for supplying electric energy to the auxiliary device 3 and/or portable communication device 4. The installation recess 9a of the adapter 2 can, for example, have strip-like metallic conductors and the auxiliary device 3 can have electrically conductive counter members fitting into these, whereby when the auxiliary device 3 is installed in the installation recess 9a, an electrically conductive connection is formed between the adapter's 2 strip-like metallic conductors and the auxiliary device's 3 counter members and electric energy can be transferred from the adapter's power source to the auxiliary device 3 and from there to the portable communication device 4.

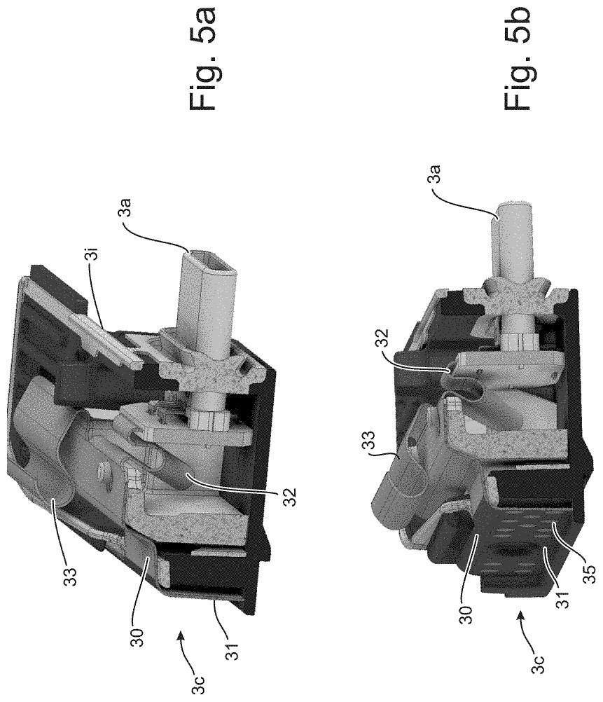

FIGS. 4a and 4b show a perspective view of an auxiliary device 3 according to a second embodiment of the present disclosure seen from below and above, and FIG. 4c further shows a cross-section of the first end 3d of the auxiliary device 3 according to FIGS. 4a and 4b. FIGS. 5a and 5b show a detail of the structure of the wire connector 3c of the auxiliary device 3 according to FIGS. 4a and 4b. In this embodiment the wire connection 3c is implemented with the aid of a flexible, film-like cable 30. The first end 31 of the cable 30 is attached to the wall of that end of the auxiliary device which is toward the wire connection 3c, so that the coupling surfaces 35 in the cable 30 are at the location of the corresponding coupling surfaces (keys) of the wire connector 5 possibly to be attached to the auxiliary device, whereby an electrically conductive connection is formed between the wire connector 5 and the cable 30. Such an arrangement makes it easier to fit the wire connection 3c to suit different wire connectors, because it can occur by using a cable, where the coupling surfaces are formed to fit the wire connector 5 intended to be connected to the auxiliary device. The second end 32 of the cable 30 is connected to a connector 3a in the auxiliary device, whereby for example power supply and signalling can be led via the cable 30 from the wire connector 5 to the portable communication device 4 attached to the auxiliary device 3.

In the embodiment of FIGS. 4a-5b, the cable 30 further has a branching part 33, which extends to the first end 3d of the auxiliary device 3. The end 34 of this branching part 33 is attached to the first end 3d of the auxiliary device. In the end 34 of the branching part 33 there is also a group of coupling surfaces 36, which can be connected to coupling surfaces (not shown in the enclosed figures) possibly in the adapter 2 in a case, where the adapter 2 also has electrically functioning couplings. The number and location of coupling surfaces 36 in the end 34 of this branching part 33 can also easily be changed by selecting a cable 30 suited for the auxiliary device. It is however clear that the cable 30 does not need to have this branching part 33 among others for solutions where it is not necessary to relay electric couplings to the adapter 2 from the wire connector 5 and/or wire connection 3c of the auxiliary device.

The location of the connector 3a in the auxiliary device 3 according to an advantageous embodiment of the present disclosure can to some extent be changed among others in the lateral direction, so that the connector 3a settles on the location of the corresponding connector of the portable communication device 4 to be set in the auxiliary device 3. In the example of FIG. 5a, this is arranged with the aid of a slide arrangement 3i above the connector 3a, but this can also be mechanically implemented in some other way. The flexibility of the cable 30 makes it easier for the connector 3a not to have to be always located in the same place.

The present disclosure is not limited solely to the above-presented embodiments, but it can be modified within the scope of the appended claims.

1. An apparatus, which comprises an adapter and an auxiliary device configured to be connected in connection therewith, which apparatus is configured to be connected in connection with a portable communication device, and which adapter comprises first attaching means for attaching to the portable communication device, a set of openings for external functions of the portable communication device, and second attaching means for connecting the auxiliary device to the adapter, wherein the auxiliary device comprises a connector for forming a wired data transfer and/or electricity connection between the portable communication device and auxiliary device.

2. The apparatus according to claim 1, the auxiliary device additionally comprising at least
a wire connection, and
a flexible, film-like cable for achieving an electrical connection between the connector and the wire connection.

3. The apparatus according to claim 1, the auxiliary device additionally comprising at least one sensor.

4. The apparatus according to claim 3, wherein said at least one sensor is a positioning receiver and/or gas sensor.

5. The apparatus according to claim 3, wherein said at least one sensor is an acceleration sensor, which is configured to monitor if the auxiliary device is in motion or stationary.

6. The apparatus according to claim 5, wherein the apparatus is with the aid of the acceleration sensor configured to deduce the operational readiness of the user of the communication device, and if there is a need to form an automatic alarm.

7. The apparatus according to claim 1, wherein the second attaching means comprise an installation recess, wherein the auxiliary device is configured to be placed.

8. The apparatus according to claim 1, wherein the second attaching means comprise at least one locking means.

9. The apparatus according to claim 1, wherein the first attaching means comprise a counter surface against which the rear cover of the portable communication device is configured to be set.

10. The apparatus according to claim 1, wherein the adapter comprises a border part, in which grooves have been formed, which are configured to keep the adapter attached to the portable communication device.

11. The apparatus according to claim 1, wherein the adapter is made of a flexible material.

12. A method for connecting an apparatus comprising an adapter and an auxiliary device to a portable communication device, which has a wire connector, the method comprising
selecting an adapter configured to be mechanically attached to a portable communication, in which adapter a set of openings has been formed for external connectors of the portable communication device;
connecting an auxiliary device to the adapter, which auxiliary device comprises a connector for forming a wired data transfer and/or electricity connection between the portable communication device and the auxiliary device, and attaching the adapter to the portable communication device, whereby the connector of the auxiliary device is connected to the wire connector of the portable communication device.

13. The method according to claim 12, wherein in connection with attaching the adapter, information is relayed to the portable communication device about the attaching of the adapter to the portable communication device.

14. The method according to claim 12, the method further comprising:
setting the auxiliary device close to the adapter;
sliding the auxiliary device on the surface of the installation recess in the adapter, until the first end of the auxiliary device hits the end of the installation recess; and
locking the auxiliary device in the adapter by one or more locking elements in the end of the installation recess.

15. An adapter for connecting an auxiliary device in connection with a portable communication device, which adapter comprises first attaching means for attaching to a portable communication device, a set of openings for external functions of the portable communication device, and second attaching means for connecting the auxiliary device to the adapter, wherein the auxiliary device comprises a connector for forming a wired data transfer and/or electricity connection between the portable communication device and the auxiliary device.
